(19) United States
(12) Patent Application Publication
(10) Pub. No.: US 2005/0088289 A1
(43) Pub. Date: Apr. 28, 2005

(54) Split-responsibility medication reminder system, and associated methods

(76) Inventor: Marc Rochkind, Boulder, CO (US)

Correspondence Address: LATHROP & GAGE LC, 4845 PEARL EAST CIRCLE, SUITE 300, BOULDER, CO, 80301, US

(21) Appl. No.: 10/962,309

(22) Filed: Oct. 8, 2004

Related U.S. Application Data
(60) Provisional application No. 60/510,416, filed on Oct. 10, 2003.

(51) Int. Cl. G08B 1/00

(52) U.S. Cl. 340/309.16

(57) ABSTRACT

Systems, methods and software products provide split-responsibility medication reminders. An interface terminal reminds a patient to take medication, the interface terminal being responsive to patient interaction to signal compliance over a network. A control center networks with the interface terminal to generate medication reminders at the interface terminal in response to inputs by a caregiver through the network.

### RELATED APPLICATIONS

This is a nonprovisional application of U.S. patent application Ser. No. 60/510,416, filed Oct. 10, 2003, the disclosure of which is herein incorporated by reference.

### BACKGROUND

The prior art is familiar with certain medication reminder technologies. In one example, a concerned caregiver for a person requiring medication (“patient”) utilizes the telephone or pager to remind the patient to take the medication at a particular time. However, the use of a telephone or pager is intrusive, particularly if the patient has multiple medications taken over the course of a day. Moreover, there is no feedback to the concerned caregiver that the patient in fact took the medication.

Certain other medication reminder technologies employ complex electronics, such as a medication-dispensing device that automatically sends a compliance signal to a computer when the patient takes his or her medication, or a smart bottle cap that detects and reports access to medication. Such complex electronics are however difficult for elderly patients to use, and are usually costly to implement and maintain. Often, the patient taking the medication is solely responsible for his or her use of the electronics.

Improvements are desirable to medication reminder technologies so that patients and caregivers easily and quickly interact regarding medication for the patient.

### SUMMARY OF THE INVENTION

In one embodiment, a split-responsibility medication reminder system is provided. An interface terminal reminds a patient to take medication, the interface terminal being responsive to patient interaction to signal compliance over a network. A control center networks with the interface terminal to generate medication reminders at the interface terminal in response to inputs by a caregiver through the network.

In one embodiment, a split-responsibility medication reminder system is provided, including: means responsive to patient interaction with an interface terminal to signal compliance over a network; and means for generating medication reminders at the interface terminal in response to inputs by a caregiver through the network.

In one embodiment, A software product has instructions, stored on computer-readable media, wherein the instructions, when executed by a computer, perform steps for providing split-responsibility medication reminders, including: instructions for responding to patient interaction with an interface terminal to signal compliance over a network; and instructions for generating medication reminders at the interface terminal in response to inputs by a caregiver through the network.

### BRIEF DESCRIPTION OF THE FIGURES

FIG. 1 is a block schematic diagram illustrating one split-responsibility medication reminder system.

FIG. 2 shows one interface terminal suitable for use with the system of FIG. 1.

FIG. 3 shows one interface terminal suitable for use with the system of FIG. 1.

FIG. 4 shows a schematic block diagram of exemplary components within one interface device.

FIG. 5 is a flow chart illustrating one exemplary web sign up process.

FIG. 6 is a flow chart illustrating one exemplary web dosage entry/edit process.

FIG. 7 is a flow chart illustrating one exemplary web patient review process.

FIG. 8 is a flow chart illustrating one exemplary continuous monitoring process.

FIG. 9 is a flow chart illustrating one exemplary web notification confirmation process.

FIG. 10 is a flow chart illustrating one exemplary reminder loop process, for use with an interface terminal.

FIG. 11 is a flow chart illustrating one exemplary call-in loop process, for use with an interface terminal.

FIG. 12 show alternative embodiments for the interface terminal of FIG. 1, for use with an interface terminal.

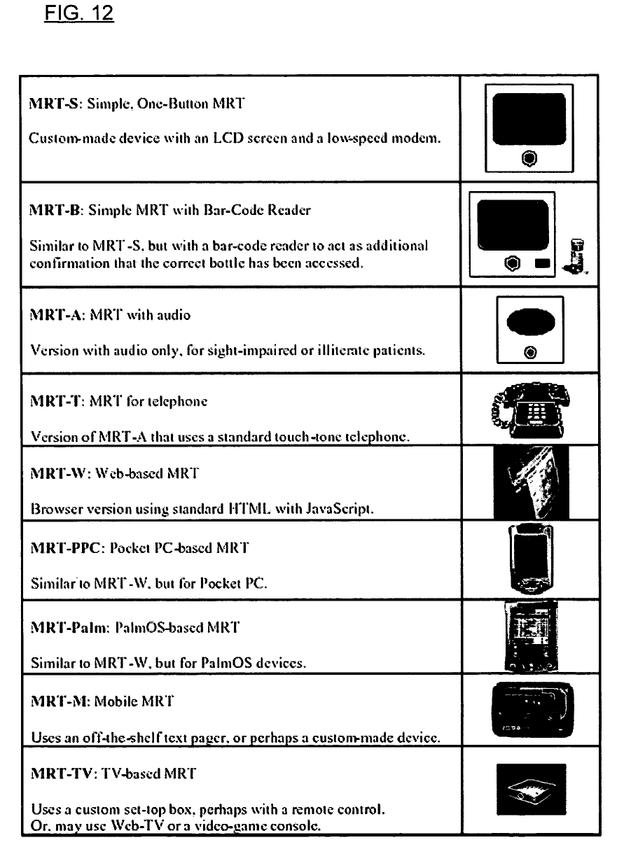

### DETAILED DESCRIPTION OF THE FIGURES

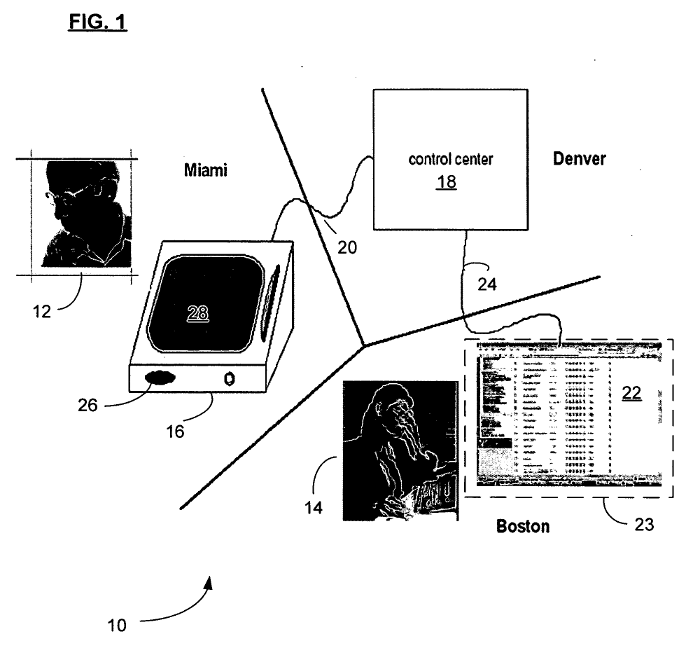

FIG. 1 shows one split-responsibility medication reminder system 10. System 10 is for example useful to provide (a) medication reminders to a patient 12 and (b) compliance information to a caregiver 14. In one embodiment, an interface terminal 16, described in more detail below, is located with patient 12 and connects to a control center 18 over a network 20. Caregiver 14 may interact with system 10 by, for example, entering medication scheduling information into a web page 22 (e.g., via a personal computer 23) linked to control center 18 by a network 24. Network 20 and network 24 may be the same network, for example the Internet. Illustratively, person 12, control center 18 and caregiver 14 may be located at different places, such as Miami, Denver and Boston, respectively (these places shown for illustrative purposes only).

In operation, person 12 is reminded of medication (according to the medication scheduling information of web page 22) at interface terminal 16. This reminder may be displayed on a screen 28 of interface terminal 16, as discussed below. Upon taking the mediation, person 12 operates interface device 16 (e.g., by pressing a single button 26 of interface device 16). In one embodiment, interface terminal 16 responds to this operation to store data indicating compliance of patient 12; interface terminal 16 then periodically transmits the data to control center 18 such that caregiver 14 may access the data through web page 22. In another embodiment, interface terminal 16 responds to the operation (of patient 12 with interface terminal 16) to immediately signal caregiver 14 that the medication has been taken; the signaling to caregiver 14 may for example be accomplished through indication on web page 22 and automatically through control center 18. The foregoing operations illustrate how system 10 may thus function to provide “split responsibility” between caregiver 14, who provides initial medication instructions and information and who receives compliance information, and patient 12, who is reminded to take medication and who responds to caregiver 14 through interaction with interface terminal 16.

Control center 18 may operate to implement and manage web page 22 for caregiver 14. It may further operate to automatically connect (over network 20) to interface terminal 16 at appropriate times, as set by the medication scheduling information. In one embodiment, caregiver 14 supplies credit card information and the address of patient 12 to interact with system 10. Payment may be for a single interaction or day, or for an extended period (e.g., one week, month or year, for example). Control center 18 then connects with terminal 16 to place appropriate reminders and to relay compliance information to caregiver 14.

In an alternative embodiment, control center 18 is optional, and not present within system 10. Instead, control interface terminal 16 directly accesses the medication scheduling information of web page 22 and operates similarly to connect to, and interact with, caregiver 14.

Web site 22 is typically only accessed by caregiver 14. In one embodiment, web page 22 (through control of control center 18) provides a “form” through which caregiver enters medication reminder information for terminal 16. The medication reminder information may be data supplied and/or entered by a doctor of patient 12, in another example. In turn, caregiver 14 may access web page 22 at her convenience to check on the status of compliance (e.g., did her father (as patient 12) take his mediation at 12 noon, as prescribed by her, as indicated on web page 22; the indication is generated by patient 12 through interaction with compliance button 26). In one embodiment, if confirmation is delayed or not available, control center 18 calls or emails caregiver 14 to warn her of a possible problem. In another embodiment, caregiver 14 may manage and set-up interface terminal 16 through web page 22.

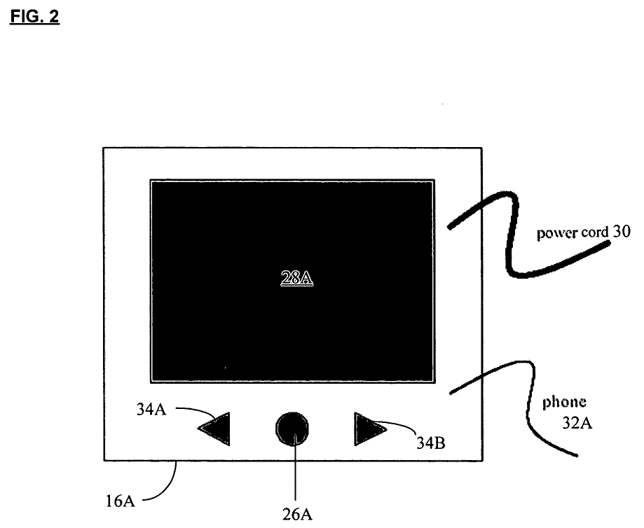

FIG. 2 shows a top view of one interface terminal device 16A. Terminal 16A is for example suitable for use as terminal 16, FIG. 1. Through a power cord 30, terminal 16A connects to power at the location of patient 12, such as through a 120V outlet at the home of patient 12. Terminal 16A further connects to network 20 by a regular telephone line 32. In one embodiment, interface terminal 16A “answers” telephone calls placed by control center 18, so that terminal 16A is “on line” with patient 12 (over network 20) to ensure compliance with medication prescribed by the mediation scheduling information of web page 22. Those skilled in the art appreciate that terminal 16A may be battery powered as a matter of design choice, in which case power cord 30 is not strictly needed. FIG. 2 further shows a pair of interface buttons 34A, 34B which optionally provide for additional interaction for patient 12, if desired (and as described below). In one example, screen 28A of interface terminal 16A shows a web page to patient 12; the web page for example directs patient 12 to take prescribed medication. Interface button 34A may thus provide for paging the web page backwards while button 34B may provide for paging the web page forward.

In an alternative embodiment, a button at interface terminal 16A (e.g., a button 34) provides for emergency notification by the patient. In one example, interface terminal 16A is responsive to this button interaction to send a message to control center 18, and thereby to caregiver 14, as to a medical emergency.

Interface terminal 16A may be “plug and play.” That is, it may be automatically configured, in accord with one embodiment, by plugging power cord 30 into house power and by plugging phone cord 32 to a phone jack. In this way, interface terminal 16A may be mailed to a mentally and/or physically challenged patient 12, who may then easily connect interface terminal 16A to system 10 by these simple operations.

Those skilled in the art appreciate that interface terminal 16, 16A may be modified for patients 12 who cannot see or hear. For example, screen 28, 28A may be replaced or augmented with a speaker which “speaks” instructions to patient 12. Moreover, terminal 16, 16A may be integrated within a television or personal computer (or PDA or cell phone or wristwatch) as a matter of design choice. By way of example, terminal 16A may comprise a personal computer wherein compliance button 26A is provided through keyboard or mouse interaction of the personal computer. In another example, terminal 16A may comprise a Internet-compliant television, which provides for user interaction (and hence compliance interaction through a compliance button 26A such as a remote control button or television button).

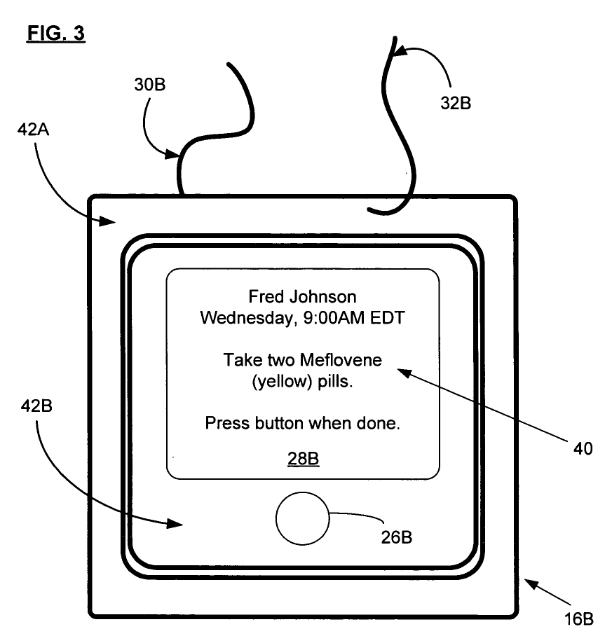

FIG. 3 shows one interface terminal 16B, which is for example suitable for use as terminal 16, FIG. 1. Terminal 16B further illustrates exemplary information 40 that may be displayed on display 28B. In one embodiment, terminal 16B is in two parts: a first part 42A connects to power and network 20 by power cord 30B and phone line 32B, respectively; while a second part 42B has display 28B and a single compliance button 26B. First part 42A is a “cradle” for second part 42B, so that patient 12 may walk around with second part 42B (to receive medication reminders and to reply, via button 26B, to caregiver 14), and then recouple second part 42B with first part 42A to repower batteries (not shown) of second part 42B. Second part 42B and first part 42A may include separate transceivers to facilitate two-way wireless communications while second part 42B is carried around by patient 12.

Those skilled in the art appreciate that phone lines 32A, 32B may be replaced with an alternative network data link without departing from the scope hereof, for example CAT5 or cable, depending on network 20 protocol.

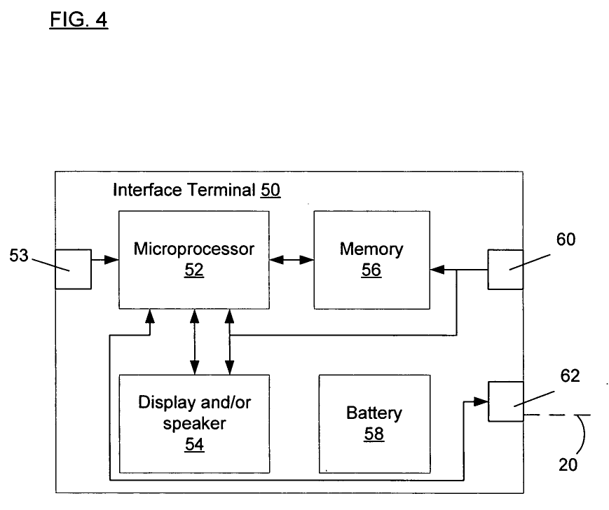

FIG. 4 shows one exemplary embodiment of an interface terminal 50. A microprocessor 52 controls terminal 50 so as to interact with web page 22, as discussed above. For example, microprocessor 52 operates to send a message over network 20 when patient 12 presses a compliance button 53. A display and/or speaker 54 operate to display and/or audibly speak medication reminders to patient 12. Memory 56 may locally store medication scheduling information as a matter of design choice (or the information may be stored within microprocessor 52). Data to and from control center 18 (FIG. 1) is illustratively communicated to microprocessor 52 as shown through a data port 62. Terminal 50 may be powered through a power port 60, as shown. Optionally, a battery 58 provides powers to components of terminal 50, as shown.

It should be apparent by the foregoing that pressing a compliance button (e.g., button 26, FIG. 1) may result in local storage of compliance information within interface terminal 16, in accord with one embodiment. This data is then conveniently downloaded, in this example, to control center 18 at periodic times (e.g., 10 times per day) by dial-up through phone line 32, FIG. 2. Accordingly, terminal 16 need not be “on-line” with network 20 at all times. The periodic download may be selected to be sufficient to accommodate scheduling of caregiver 14 (who will typically check web page 22 also at periodic time periods (e.g., twice per day)).

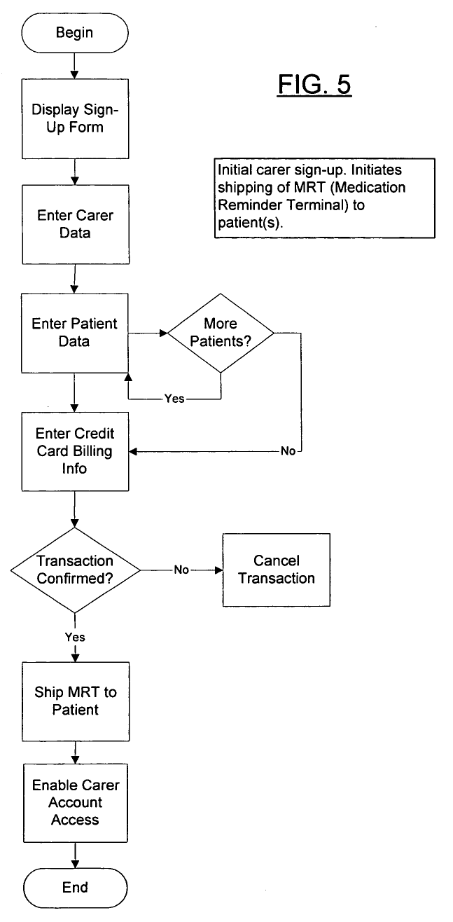

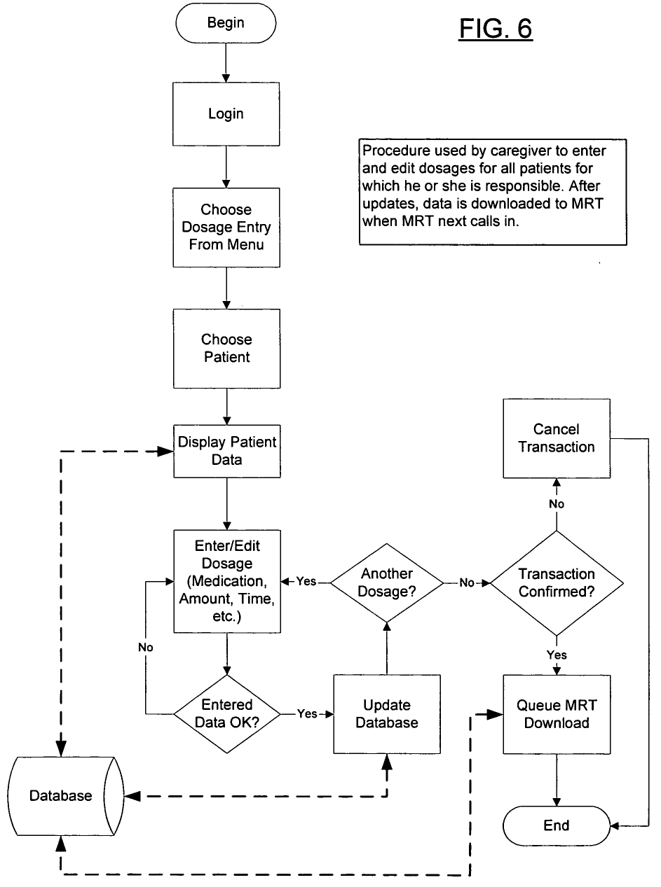

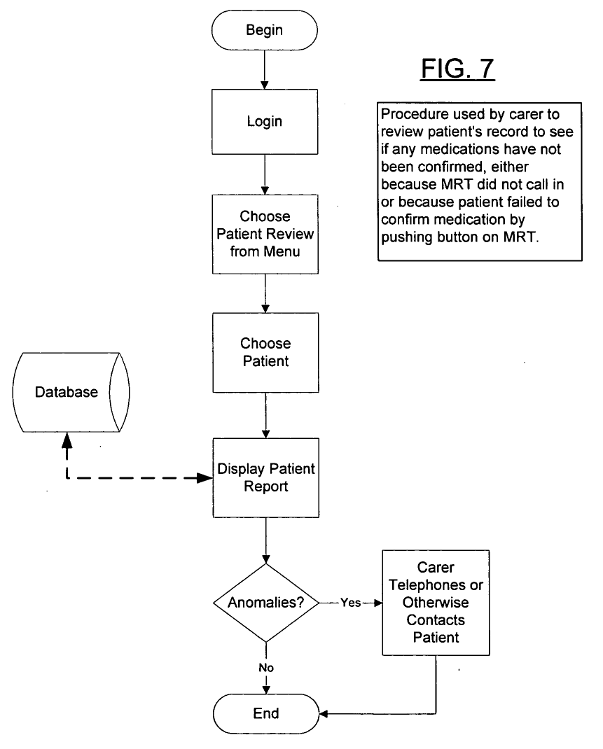

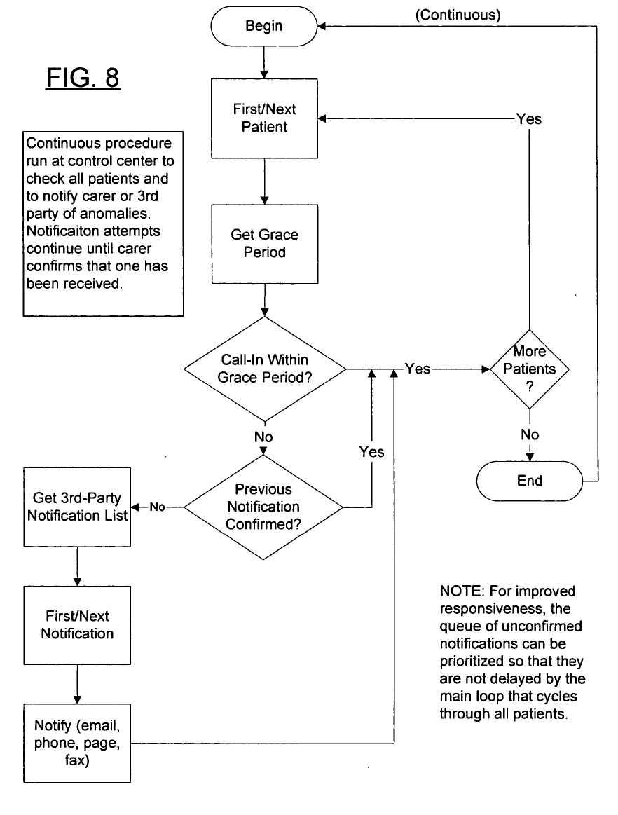

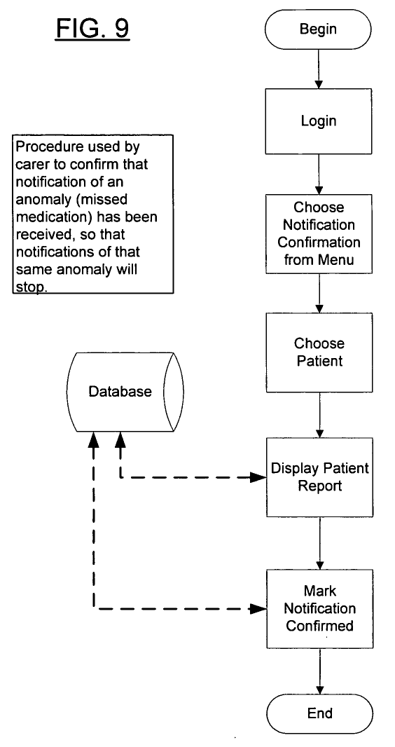

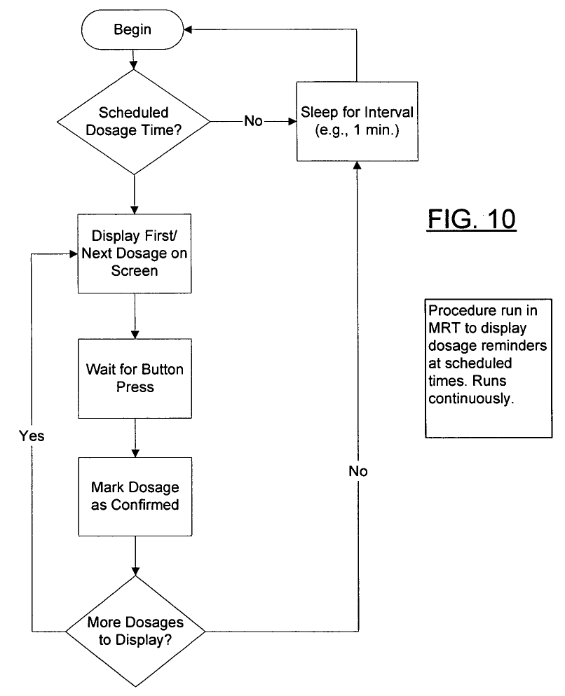

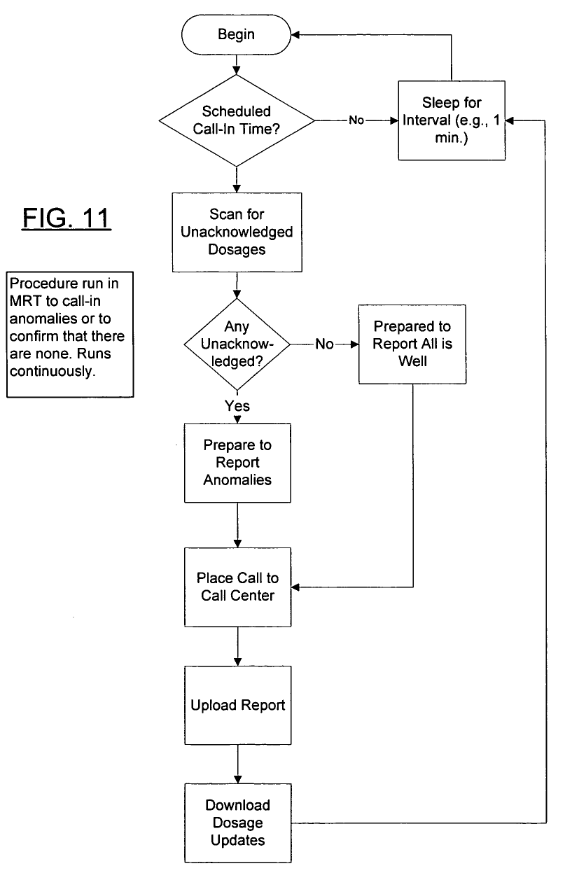

FIGS. 5-FIG. 11 show flowcharts suitable for use with system 10, FIG. 1. Interface terminal 16 may be referred to as “MRT” in these flowcharts. FIG. 5 is a flow chart illustrating one exemplary web sign up process. The process of FIG. 5 is for example implemented through the Internet by caregiver 14 interacting with control center 18. FIG. 6 is a flow chart illustrating one exemplary web dosage entry/edit process. The process of FIG. 6 is for example implemented by control center 18 and shown to caregiver 14 through web page 22. The databases of FIG. 6 may reside at control center 18, for example. FIG. 7 is a flow chart illustrating one exemplary web patient review process. The process of FIG. 7 is for example implemented by control center 18 and configured for interaction with caregiver 14 through web page 22. FIG. 8 is a flow chart illustrating one exemplary continuous monitoring process. The process of FIG. 8 is for example implemented by control center 18 in interacting with interface terminal 16, with patient 12, and computer 23, with caregiver 14. FIG. 9 is a flow chart illustrating one exemplary web notification confirmation process. The process of FIG. 9 is for example implemented by control center 18 in interaction with caregiver 14 through web page 22. FIG. 10 is a flow chart illustrating one exemplary reminder loop process. The process of FIG. 10 is for example implemented by interface terminal 16, 16A, 16B. FIG. 11 is a flow chart illustrating one exemplary call-in loop process. The process of FIG. 10 is for example implemented by interface terminal 16, 16A, 16B.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

1. A split-responsibility medication reminder system, comprising:
an interface terminal for reminding a patient to take medication, the interface terminal being responsive to patient interaction to signal compliance over a network; and
a control center for networking with the interface terminal to generate medication reminders at the interface terminal in response to inputs by a caregiver through the network.

2. The system of claim 1, the interface terminal comprising a button, the button indicating the compliance when pressed by the patient.

3. The system of claim 1, further comprising at least one computer through which the caregiver accesses compliance information and inputting medication scheduling information used to generate the medication reminders.

4. The system of claim 1, the interface terminal being configured for plug and play wherein the patient plugs the terminal into a data port and the terminal automatically configures for operation with the control center.

5. The system of claim 4, the interface terminal comprising a phone line for connecting the interface terminal to the data port.

6. The system of claim 4, the interface terminal comprising a power line for connecting the interface terminal to power.

7. The system of claim 1, the interface terminal comprising one or both of a display screen and a speaker, for generating the medication reminders to the patient.

8. The system of claim 1, further comprising a web page obtainable through the network, the control center responsive to caregiver interaction with the web page to set the medication reminders at the interface terminal.

9. The system of claim 8, the control center responsive to the patient interaction to update the web page so that the caregiver can review the compliance through the web page.

10. The system of claim 1, the medication reminders comprising audible sound generated by the interface terminal.

11. The system of claim 1, the medication reminders comprising displayed data on a display of the interface terminal.

12. The system of claim 1, the interface terminal comprising one of a desktop computer, a television, a laptop, a cell phone, wristwatch and PDA.

13. The system of claim 1, the interface terminal being further responsive to patient interaction to signal the caregiver of a medical emergency.

14. The system of claim 1, the control center signaling the caregiver in the absence of compliance signaling after a period of time.

15. The system of claim 1, the control center signaling unusual behavior in patient compliance.

16. The system of claim 1, the interface terminal comprising a cradle part and a hand-held part, the cradle part and hand-held part being in wireless communication when the hand-held part is out of the cradle part.

17. The system of claim 1, the interface terminal being configured to store compliance data for periodic download to the control center.

18. The system of claim 17, the interface terminal being configured to dial into the control center at selected, periodic time periods.

19. The system of claim 1, the interface terminal comprising a phone line for connection to a telephone jack for connection as the network.

20. The system of claim 1, the interface terminal comprising memory for storing compliance data generated in response to patient interaction with the interface terminal, and means for communicating the compliance data to the control center over the network.

21. A split-responsibility medication reminder system, comprising:
means responsive to patient interaction with an interface terminal to signal compliance over a network; and
means for generating medication reminders at the interface terminal in response to inputs by a caregiver through the network.

22. The system of claim 21, further comprising means responsive to the patient interaction to update a web page for caregiver review through the web page.

23. The system of claim 21, further comprising means for storing compliance data for periodic download to a control center.

24. The system of claim 23, further comprising means for dialing into the control center at selected, periodic time periods.

25. A software product comprising instructions, stored on computer-readable media, wherein the instructions, when executed by a computer, perform steps for providing split-responsibility medication reminders, comprising:
instructions for responding to patient interaction with an interface terminal to signal compliance over a network; and
instructions for generating medication reminders at the interface terminal in response to inputs by a caregiver through the network.

26. The software product of claim 25, further comprising instructions for storing compliance data at the interface terminal and for periodically downloading the compliance data to a web page.

27. The software product of claim 26, further comprising instructions for downloading the compliance data to a control center networked with the interface terminal.
